(19) United States
(12) Patent Application Publication
(10) Pub. No.: US 2026/0187415 A1
(43) Pub. Date: Jul. 2, 2026

(54) Cognitive Inception Detection and Defense System (CIDDS) for Human Cognitive Security

(71) Applicant: José Manuel dos Santos Carrascozinho Bonito Viegas, Lisbon (PT)

(72) Inventor: José Manuel dos Santos Carrascozinho Bonito Viegas, Lisbon (PT)

(21) Appl. No.: 19/540,714

(22) Filed: Feb. 15, 2026

Related U.S. Application Data
(60) Provisional application No. 63/954,990, filed on Jan. 6, 2026.

(51) Int. Cl. G06N 3/045; G06F 3/01; H04L 9/06

(52) U.S. Cl. CPC G06N 3/045; G06F 3/015; H04L 9/0643

(57) ABSTRACT

A computer-implemented system, method, and non-transitory medium for detecting cognitive inception risk and generating defensive interventions. The Cognitive Inception Detection and Defense System (CIDDS) receives a time-stamped content exposure stream associated with a user and user cognitive output signals (e.g., text, speech, selections, interaction events). CIDDS projects exposure and output signals into a multidimensional semantic vector space; maintains a stateful, decay-weighted baseline for the user; computes (i) a Baseline Deviation Index (BDI) and (ii) an Inception Propensity Score (IPS) derived from structural properties of exposures (e.g., priming sequences, repetition structure, microtargeting indicators, synthetic consensus indicators). CIDDS fuses these measures to generate a Cognitive Origin Authentication Score (COAS) and an interpretable origin assessment. Responsive to a confidence score satisfying a triggering condition, CIDDS outputs defensive actions including alerting, reflection prompting, exposure throttling, quarantine, blocking, or escalation, while maintaining tamper-evident audit logs. Optional embodiments incorporate non-invasive neurophysiological signals (e.g., EEG).

### CROSS-REFERENCE TO RELATED APPLICATIONS

This application claims the benefit of U.S. Provisional Patent Application No. 63/954,990, entitled “Cognitive Inception Detection and Defense System (CIDDS) for Human Cognitive Security,” filed Jan. 6, 2026, the entire disclosure of which is incorporated herein by reference.

This application is also related to U.S. patent application Ser. No. 19/231,235, entitled “Quantum Semantic Prediction and Anticipatory Response Generation Framework (QSP-EF)” by the same inventor, filed on Jun. 6, 2025.

The present application is complementary to and interoperable with the QSP-EF core pipeline—comprising the Semantic Quantum Tuning Engine (SQTE), Deviation Interpretation Module (DIM), Collapse Module, and Output Module—and extends it with a Cognitive Inception Detection and Defense System (CIDDS) for human cognitive security.

The CIDDS operates as a defensive layer between content exposure streams and human cognition, designed to detect, quantify, and defend against cognitive inception—the process by which externally-optimized content induces cognitive content that subjects may attribute to self-generation. By providing quantified scoring, triggering conditions, and tamper-evident auditability, the CIDDS enhances cognitive sovereignty, interpretability, and compliance in AI-mediated information environments.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### STATEMENT REGARDING PRIOR DISCLOSURES BY THE INVENTOR OR A JOINT INVENTOR

Not Applicable.

### BACKGROUND OF THE INVENTION

### 1. Technical Field

This application relates to cognitive security systems and methods for protecting human cognition against covert manipulation. More specifically, it discloses multi-modal and modality-agnostic systems for: (a) detecting when externally-originated or externally-optimized content streams are likely to induce cognitive content that subjects may attribute to self-generation; (b) authenticating cognitive origin with quantified scores and interpretable evidence; and (c) providing real-time defensive interventions and auditability.

Unlike cybersecurity (protecting computational systems) or information security (protecting data), the present disclosure addresses the protection of human cognitive processes as a practical attack surface in AI-mediated environments.

The invention disclosed herein is entitled “CIDDS: Cognitive Inception Detection and Defense System” (hereinafter referred to as the CIDDS or the Cognitive Inception Detection System). For consistency, the term CIDDS will be used throughout this specification to designate the disclosed system, method, or apparatus.

### 1.1 Operational Scope and Non-Mind-Reading Disclaimer

CIDDS operates exclusively on observable signals and does not require, claim, or assume access to internal mental content, subjective experience, or direct neural representations of thought. The system infers risk of externally induced ideation from observable interaction and content exposure signals; it does not decode private thought content. The system analyzes:
\(a\) Content exposure streams: externally observable sequences of content delivered to or viewed by a user, including metadata such as timestamps, sources, delivery context, and engagement metrics;
\(b\) User cognitive output signals: user-generated artifacts including text, speech, selections, interaction events, and behavioral telemetry (e.g., dwell time, typing dynamics), which serve as observable proxies for cognitive state;
\(c\) Optional neurophysiological signals: when available, non-invasive sensor data (e.g., EEG) providing additional evidentiary weight, but not constituting “mind reading”—such signals reflect aggregate neural activity patterns correlated with cognitive states, not direct access to thought content.

The COAS metric represents a statistical estimate of the likelihood that observed cognitive outputs were influenced by specific exposure patterns, based on measurable correlations and deviations from established baselines. CIDDS makes no metaphysical claims about the nature of thought, consciousness, or cognitive ownership. The system is designed to be technically implementable using existing signal processing, machine learning, and semantic analysis techniques.

### 2. Description of Related Art

### 2.1 Technical Context of the Problem

Modern information environments increasingly mediate cognition through algorithmic curation, personalized recommendation systems, and generative AI. Such systems can influence cognition through, for example: micro-targeting (delivery calibrated to inferred psychological/behavioral profiles); temporal sequencing (ordering to establish priming trajectories); repetition structure (spacing/frequency to maximize retention and salience); synthetic consensus (coordinated inauthentic behavior and manufactured social proof); and attention capture (interface and content patterns that reduce reflective processing).

The convergence of large-scale behavioral data with adaptive AI content generation introduces an emerging threat landscape in which cognitive manipulation can be individualized, scalable, and difficult to detect.

### 2.2 Scientific Foundation and Empirical Basis

The threat model underlying CIDDS is grounded in established scientific literature demonstrating the feasibility and efficacy of algorithmic influence on human cognition:

### Predictability of Psychological Traits From Digital Behavior

Research has demonstrated that psychological attributes including personality traits, political orientation, and cognitive styles can be inferred from digital records of human behavior with accuracy exceeding human judges [1]. This establishes that content delivery systems have access to psychologically-relevant targeting information.

Efficacy of psychological targeting: Experimental studies have shown that psychological targeting—matching persuasive content to inferred personality profiles—significantly increases persuasion efficacy compared to non-targeted messaging [2]. This validates the threat vector of personalized influence.

Large-scale emotional contagion: Platform-scale experiments have demonstrated that algorithmically-mediated exposure to emotional content can alter users\′ subsequent emotional expression without awareness of the manipulation [3]. This establishes that feed manipulation produces measurable cognitive/affective effects.

Priming and automaticity: Decades of research in social cognition demonstrate that exposure to stimuli can activate concepts and behavioral tendencies without conscious awareness [4]. While effect sizes in priming research are subject to ongoing methodological debate [5], the existence of exposure-mediated influence on subsequent cognition is established, and CIDDS is designed with multi-signal robustness to account for variable effect magnitudes.

Coordinated inauthentic behavior (CIB): Documented campaigns involving bot networks, astroturfing, and manufactured consensus demonstrate that exposure streams can be deliberately manipulated at scale to simulate organic opinion trends [6]. CIDDS incorporates synthetic consensus detection (f_syn) to identify such coordination patterns.

Neural correlates of cognitive states: EEG research has established reliable correlates of attention, memory encoding, prediction error, and cross-frequency coupling that track cognitive processing [7][8]. CIDDS leverages such signals as optional corroborative evidence, without claiming semantic decoding of thought content.
Note: Citations [1]-[8] refer to the References section (Section 15). Nothing herein constitutes an admission that any cited work anticipates or renders obvious the claimed invention. The CIDDS contribution lies in the novel integration of these insights into an operational detection and defense system.

### 2.3 Threat Model and Adversary Classes

CIDDS is designed to detect and defend against three distinct classes of cognitive manipulation threats:

### Level 1—Organic Manipulation (TRADITIONAL PROPAGANDA):

Human-generated persuasive content without algorithmic optimization. Characteristics: static messaging, broad targeting, limited personalization. Detection signals: low f_tgt scores, minimal temporal optimization, absence of coordination markers. CIDDS baseline sensitivity: standard thresholds.

### Level 2—Algorithmic Manipulation (Recommender/Micro-Targeting)

Platform-mediated content optimization based on behavioral inference [1][2]. Characteristics: personalized delivery, engagement-optimized timing, profile-calibrated framing. Detection signals: elevated f_tgt scores, repetition patterns matching retention optimization, cross-platform behavioral correlation. CIDDS response: enhanced monitoring, pre-exposure labeling.

### Level 3—Coordinated Inauthentic Behavior (CIB)

Multi-actor campaigns with synthetic consensus generation [6]. Characteristics: coordinated timing across sources, manufactured social proof, scripted narrative progression, bot/troll network amplification. Detection signals: high f_syn scores, timing clustering, phrasing similarity across ostensibly independent sources, engagement pattern anomalies. CIDDS response: aggressive intervention, quarantine, escalation.

Each threat level requires progressively more sensitive detection thresholds and more assertive intervention responses. CIDDS implements threat-level-aware policy configuration.

### 2.4 Operational Definition: Cognitive Inception

For purposes of this specification, cognitive inception (also referred to as cognitive induction) means an externally driven process—deliberate or emergent—by which a content exposure stream induces cognitive content (thoughts, beliefs, preferences, intentions, or decision tendencies) in a subject in a manner that: (1) biases subsequent cognition or action; (2) is optimized through feedback and personalization; and (3) may be experienced by the subject as self-generated (i.e., with reduced awareness of external causation).

CIDDS does not require proving a metaphysical claim about “ownership” of thought. CIDDS provides a quantified, evidence-based estimate of likely external induction, based on measurable signals. For avoidance of doubt, “cognitive inception” as used herein refers exclusively to measurable statistical relationships between exposure stream structure and subsequent user output deviation, and does not imply direct access to, inference of, or claim over internal subjective mental states.

### 2.5 Limitations of Conventional Systems

Conventional defenses are inadequate because they typically operate at the information layer (fact checking, moderation) and presume conscious scrutiny. They do not provide: (a) pre-exposure detection of induction-optimized content streams; (b) individualized baseline deviation monitoring; (c) quantified origin scoring with triggering conditions; or (d) tamper-evident audit logs and compliance-ready evidence bundles.

### 2.6 Motivation for the CIDDS Extension

CIDDS addresses the above by introducing: (1) semantic projection plus baseline deviation monitoring (stateful, decay-weighted); (2) exposure-side inception propensity scoring (sequence and structure aware); (3) origin scoring and explainable collapse (interpretable evidence bundle); (4) pre-exposure and post-exposure interventions (graduated enforcement); (5) auditability (tamper-evident logs, evidence bundles, reporting); and (6) optional neurophysiological corroboration (e.g., EEG) as an embodiment.

### 2.7 Distinction From Cognitive Security Layer (CSL), Non-Overlap Statement, and Independence

CIDDS is distinct from the Cognitive Security Layer (CSL) disclosed in related provisional applications by the same inventor. While both systems address security concerns in semantic processing contexts, they protect different targets and operate at different layers:

CSL (Cognitive Security Layer): Protects AI forecasting pipelines against adversarial data manipulation, semantic poisoning, and injection attacks. CSL operates as a supervisory firewall over the QSP-EF pipeline (SQTE→DIM→Collapse→Output), ensuring that the computational system produces reliable forecasts despite hostile inputs. Target: system and pipeline integrity.

CIDDS (Cognitive Inception Detection and Defense System): Protects human cognitive processes against content-mediated manipulation, priming sequences, and coordinated influence operations. CIDDS operates as a defensive layer between content streams and human users, ensuring that human decision-makers maintain cognitive sovereignty despite optimized exposure streams. Target: human cognitive integrity.

### 2.7.1 Independence and Non-Dependence Statement

CIDDS is a standalone system that does not depend on QSP-EF for operation. While CIDDS may leverage QSP-EF modules (SQTE, DIM, Collapse Engine) as an optional semantic processing backend in some embodiments, this integration is non-limiting and not required. CIDDS operates independently using standard semantic embedding techniques (e.g., SBERT, CLIP) without any QSP-EF components.

Any reference to “SQTE-style” or “DIM-style” processing in this specification denotes functional equivalence (semantic projection, deviation computation), not architectural dependency. The core claimed invention comprises the dual-stream architecture (exposure→IPS/output→BDI), COAS fusion, triggering conditions, graduated interventions, and tamper-evident audit—none of which require QSP-EF.

QSP-EF, when integrated, operates as an optional downstream consumer of CIDDS outputs (e.g., incorporating cognitive integrity signals into forecasting models) or as an optional upstream provider of enhanced semantic analysis. This relationship is bidirectional and optional, not unidirectional or mandatory.

### BRIEF SUMMARY OF THE INVENTION

In one embodiment, CIDDS implements the following functional pipeline:
Input→Semantic Projection→Baseline (stateful/decay)→Deviation Interpretation→Collapse/Explanation→Output/Intervention+Audit

CIDDS transforms both exposure signals and cognitive output signals into a shared semantic space, enabling cross-context comparisons and anomaly detection. CIDDS computes BDI and IPS, fuses them into COAS and a confidence score, and triggers interventions when thresholds are met.

### 3.1 CIDDS-Specific Contributions (Novel Elements Beyond QSP-EF)

CIDDS may leverage standard semantic processing techniques or QSP-EF modules as its semantic processing backend in some embodiments. However, CIDDS claims as novel the following elements that are not present in QSP-EF and constitute the inventive contribution of this application:
\(1\) Content Exposure Stream Analysis: Time-stamped sequences of content items with delivery metadata, provenance tracking, and engagement metrics—a structural input type for analyzing influence pathways, not defined in QSP-EF.

\(2\) Cognitive Origin Authentication Score (COAS): A fused metric specifically designed to estimate probability of organic versus induced cognitive origin—a metric type addressing human cognitive integrity, not present in QSP-EF\'s deviation classification (PS/CCS/MCD/LCS/Noise) which addresses semantic forecasting.

\(3\) Pre-Exposure Filtering and Intervention Gating: Defensive actions applied to content streams before exposure to the user—a control mechanism protecting human cognition, not contemplated in QSP-EF\'s post-hoc forecasting architecture.

\(4\) Human Baseline Drift Modeling: User-specific semantic fingerprints tracking individual cognitive/linguistic patterns over time—a personalization layer for individual cognitive security, distinct from QSP-EF\'s domain-level semantic modeling.

These four elements constitute the CIDDS-specific contributions that extend beyond the QSP-EF disclosure while maintaining architectural compatibility.

### 3.2 Technical Improvement Over Prior Systems

CIDDS provides concrete technical improvements to the functionality of content mediation and cognitive security systems:
\(i\) Dual-stream scoring architecture that jointly analyzes exposure properties (IPS) and user output deviation (BDI), enabling detection of causal influence pathways not possible with single-stream analysis;
\(ii\) Real-time policy gating with sub-100 ms latency for pre-exposure intervention, enabling defensive action before cognitive impact occurs;
\(iii\) Hash-chained tamper-evident audit logs with cryptographic integrity verification, providing forensic evidence suitable for governance and legal proceedings;
\(iv\) Threat-level-aware threshold calibration that automatically adjusts sensitivity based on detected adversary sophistication (L1/L2/L3), reducing false positives while maintaining detection efficacy;
\(v\) Graduated intervention hierarchy from labeling through blocking, enabling proportionate response without over-intervention;
\(vi\) Privacy-preserving on-device processing with federated learning capability, enabling deployment without centralized data collection.

These improvements are not abstract concepts but concrete technical enhancements to the operation of content mediation systems, producing measurable improvements in detection accuracy, intervention latency, audit integrity, and privacy preservation.

### BRIEF DESCRIPTION OF THE DRAWINGS

FIG. 1—High-Level CIDDS Architecture (Two-Stream: Exposure→IPS+Output→BDI→COAS→Intervention). Supports Claims 1, 2.

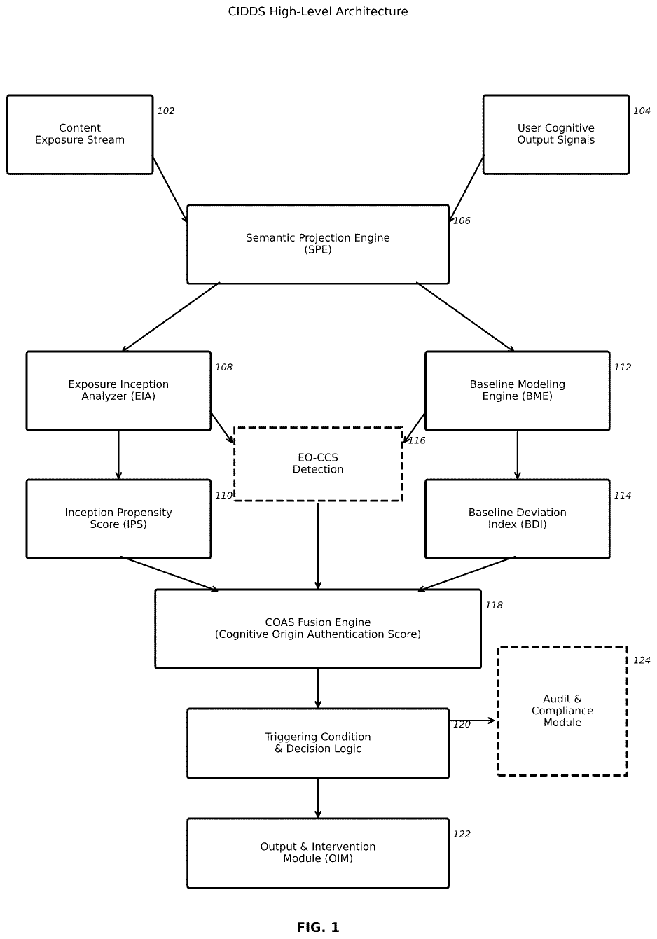

FIG. 2—Baseline (Stateful, Decay-Weighted) Update+BDI Computation. Supports Claims 1, 5.

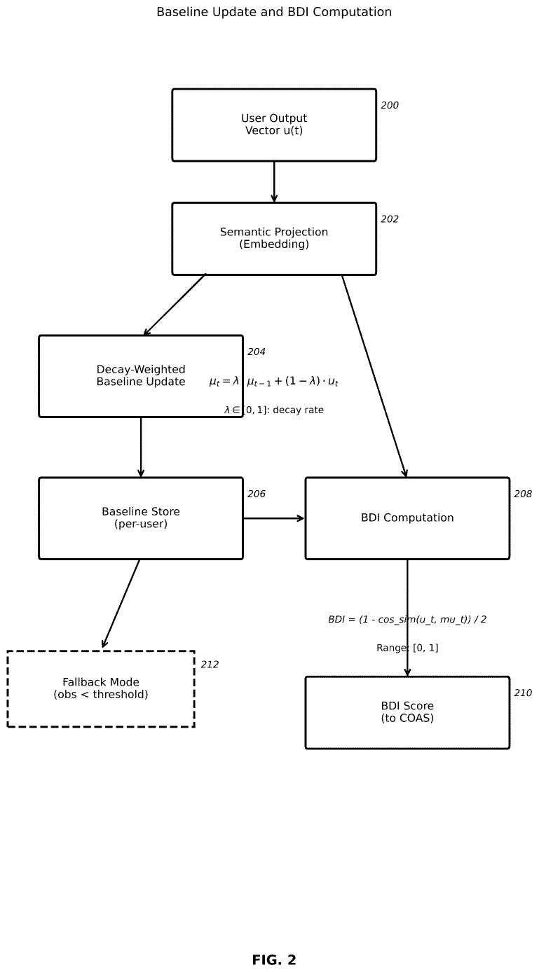

FIG. 3—Exposure-Side IPS Computation (f_seq+f_rep+f_tgt+f_syn). Supports Claims 1, 7, 19.

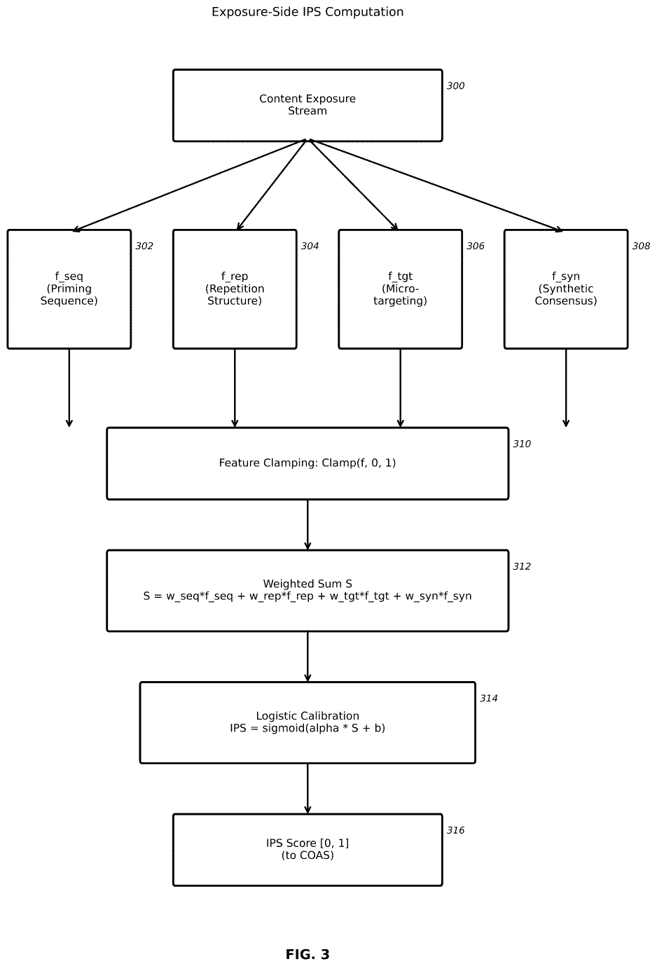

FIG. 4—COAS Fusion+Triggering Condition+Graduated Interventions. Supports Claims 1, 9, 17, 18.

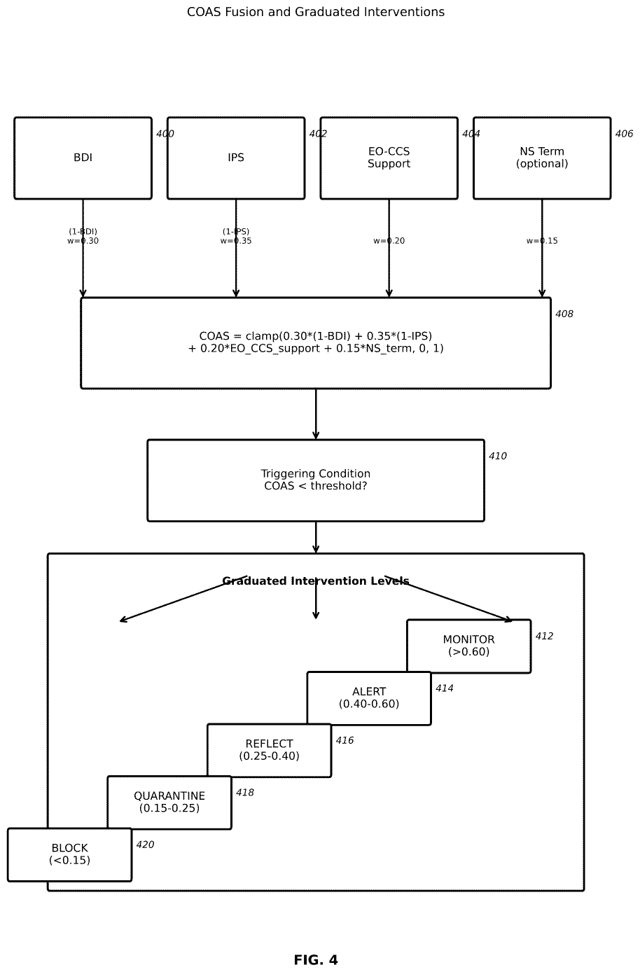

FIG. 5—Audit/Evidence Bundle+Tamper-Evident Hash Chain. Supports Claims 8, 10, 11.

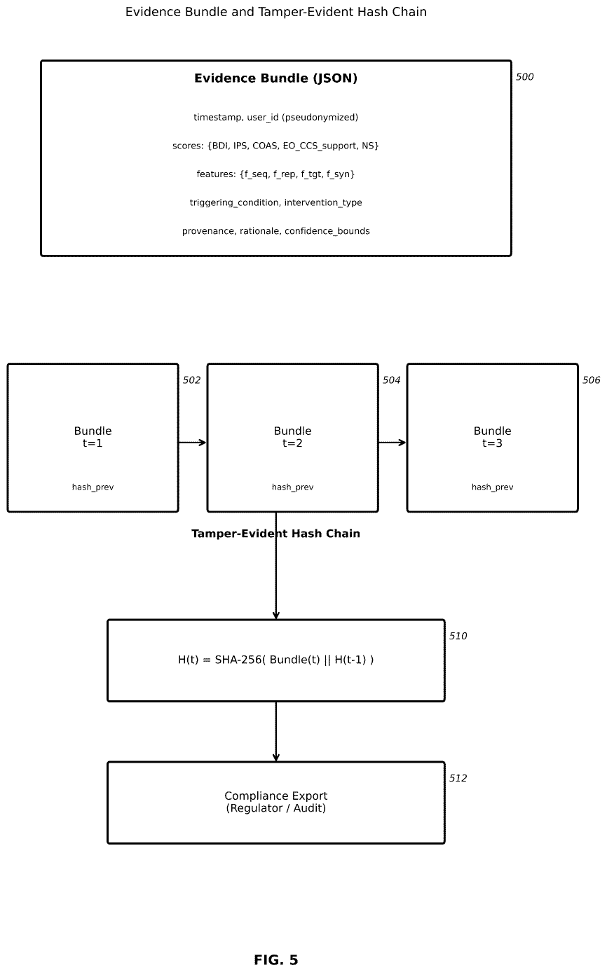

FIG. 6—Deployment Modes: On-Device/Gateway/Enterprise. Supports Claims 4, 16, 20.

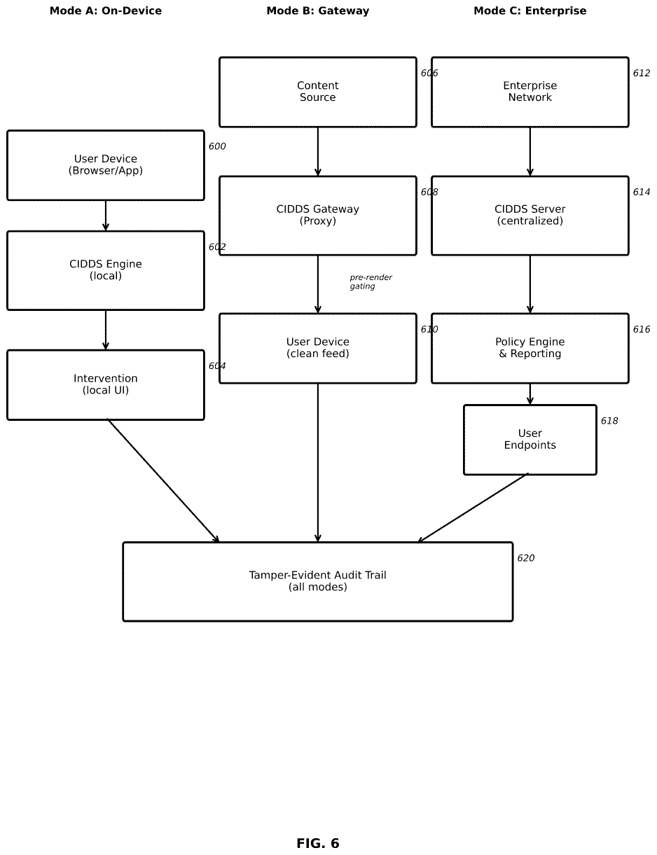

FIG. 7—Worked Example: Organic Drift (Ex. A) vs. Induced Trajectory (Ex. B). Supports enablement.

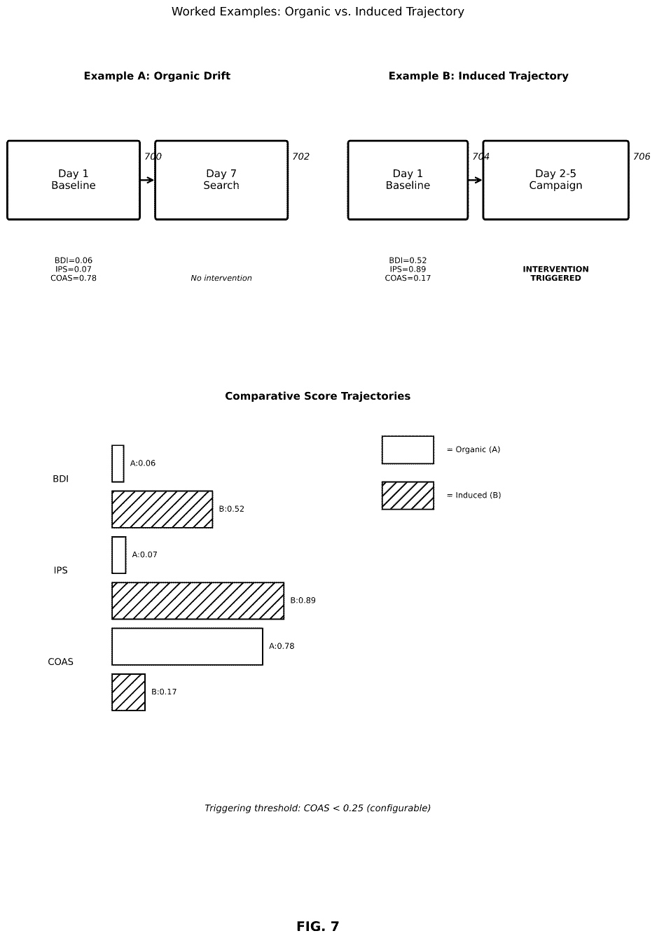

FIG. 8—Software-Only Embodiment Architecture. Supports Claim 22.

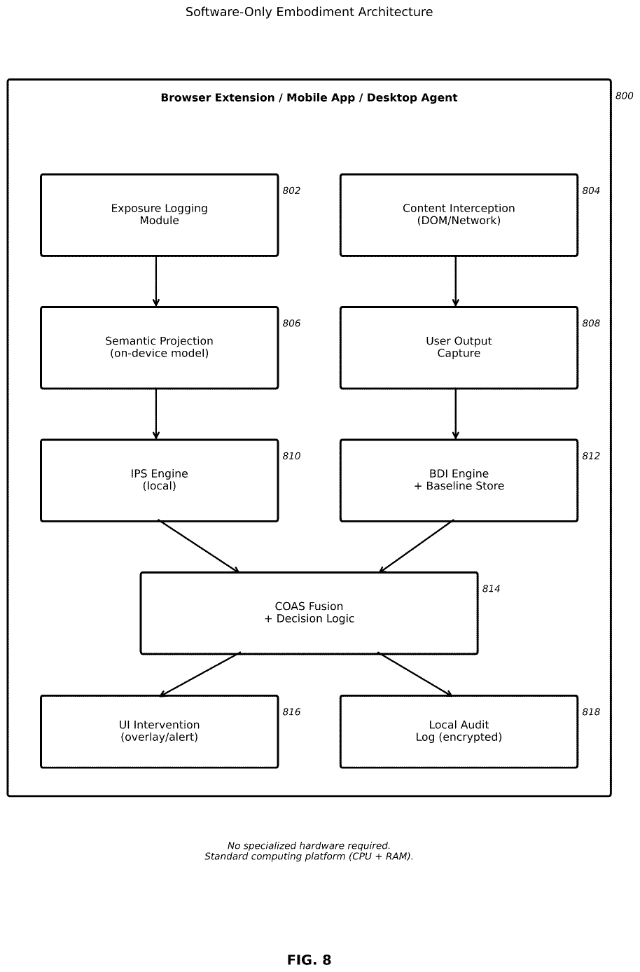

FIG. 9—Threat Model: Three Adversary Classes (L1/L2/L3) and Response Matrix. Supports Claim 18.

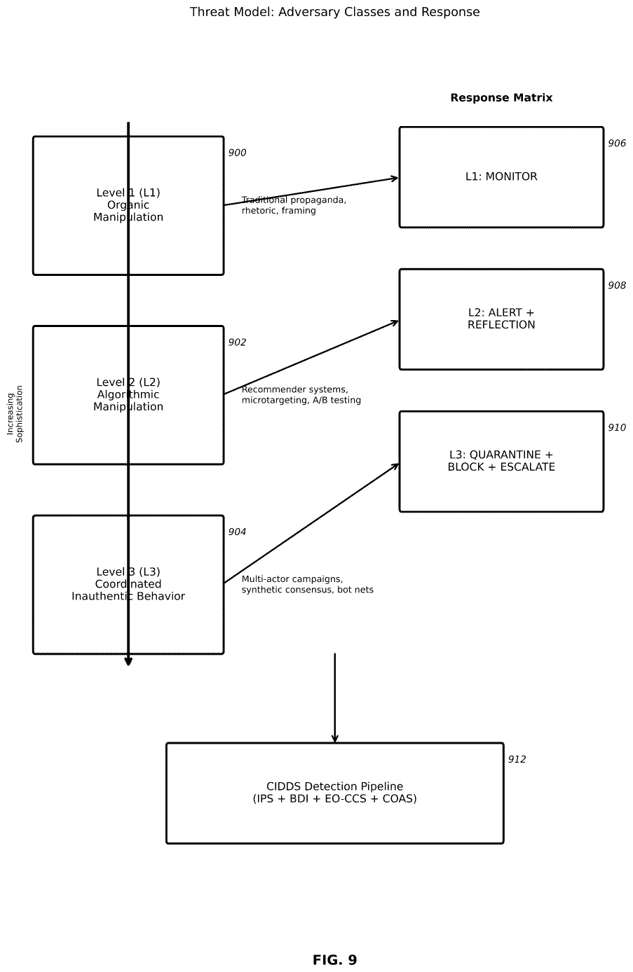

FIG. 10—CIDDS vs CSL: Complementary Protection Domains (Human vs Pipeline). Supports portfolio coherence.

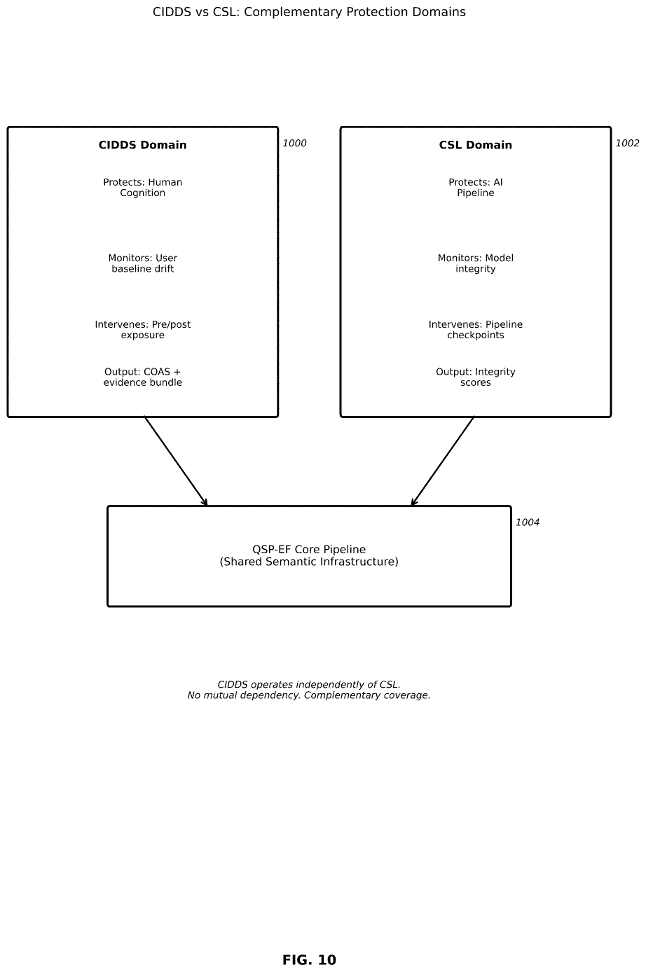

FIG. 11—Privacy-by-Design Architecture. Supports Claim 21.

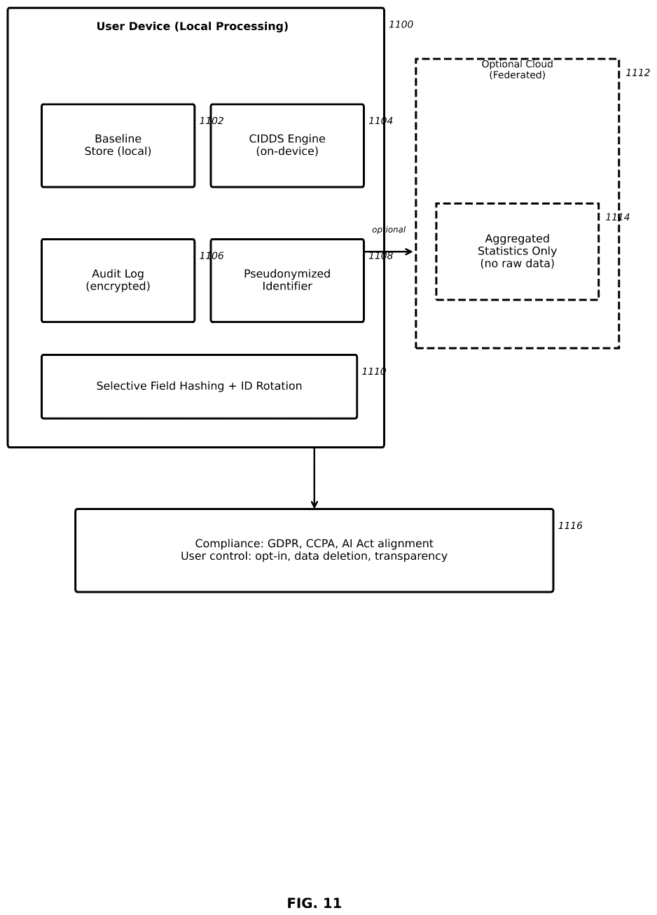

FIG. 12—Wearable/AR Multimodal Pipeline: Sensors→Feature Extraction→IPS/BDI/EO-CCS→COAS Fusion→Intervention (HUD/Audio/Evidence). Includes Calibration Engine with Drift Monitoring. Supports Claims 23, 24, 25, 26.

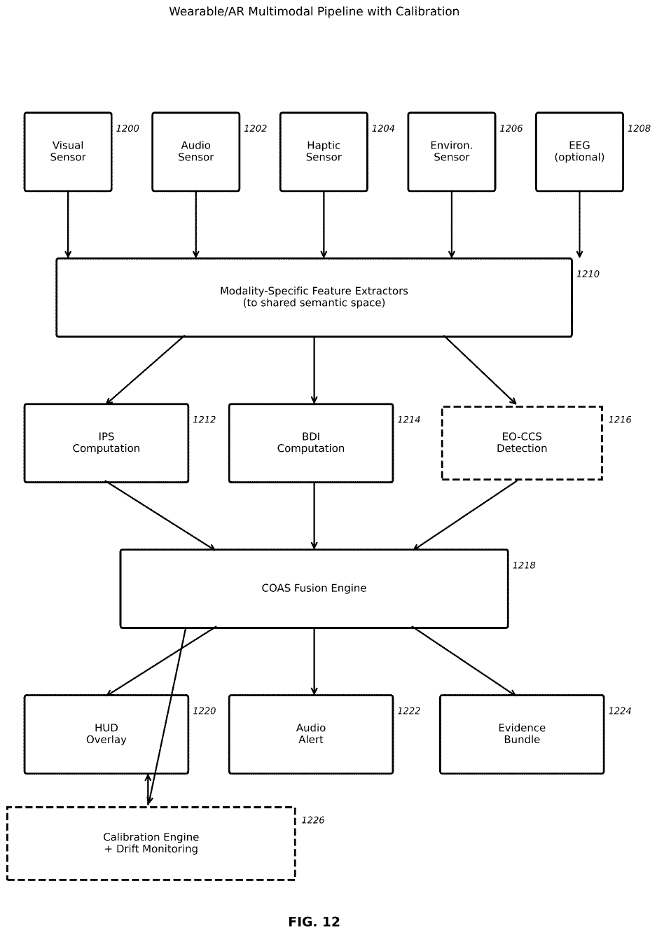

### DETAILED DESCRIPTION OF THE INVENTION

The following detailed description sets forth specific embodiments of the Cognitive Inception Detection and Defense System (CIDDS). These embodiments are illustrative and non-limiting. The scope of the invention is defined by the appended claims.

### Definitions (Non-Limiting)

### Non-Limiting

Content exposure stream: a time-stamped sequence of content items delivered to, viewed by, or otherwise exposed to a user, including provenance metadata (source, channel, delivery context, interaction metrics). This is a required structural element for CIDDS operation. Each exposure event comprises: timestamp (ISO 8601, millisecond precision); source identifier (URL, app, platform); content type (text, image, video, mixed); content hash (SHA-256); engagement metrics (dwell time, scroll depth, interactions); delivery context (feed position, notification type, referrer, campaign ID if available).

User cognitive output signals: user-generated or user-selected signals reflecting cognition, including text, speech, choices, interaction events, and on-device behavioral signals (e.g., dwell time, latency). Each output event comprises: timestamp; modality (text, voice, selection, action); content or action identifier; embedding vector; confidence score; provenance (application, context).

Semantic projection engine: a component that projects signals into a vector space (e.g., embedding space) to compute similarity, drift, and cross-context signatures.
Baseline model: a user-specific distributional model of semantic and behavioral patterns maintained over time using stateful, decay-weighted updating.
BDI (Baseline Deviation Index): a measure of deviation between current user outputs and the baseline model, normalized to [0, 1].
IPS (Inception Propensity Score): a measure of induction-likelihood derived from exposure structure, sequencing, repetition, microtargeting indicators, and/or synthetic consensus indicators, normalized to [0, 1].
COAS (Cognitive Origin Authentication Score): a fused score estimating probability of organic (endogenous) origin versus externally induced origin, given evidentiary channels; COAS is not a claim about certainty, but a quantified confidence measure, normalized to [0, 1].
EO-CCS (Exposure-Output Cross-Contextual Signature): In the CIDDS context, a statistically unlikely semantic convergence between content exposure (exposure domain) and subsequent user cognitive output (output domain) within a defined temporal window. Statistical rarity may be assessed via permutation tests, bootstrap estimation, or other non-parametric significance testing over similarity distributions. To ensure deterministic reproducibility, the random seed for permutation or bootstrap sampling is derived deterministically from the SHA-256 hash of the concatenated, chronologically-ordered input vectors; both the seed value and the number of permutation samples (N) are recorded in the evidence bundle, enabling exact reproduction of significance results from identical inputs. EO-CCS is distinct from CCS as defined in QSP-EF; here it refers specifically to signatures between the exposure stream and baseline drift of the individual human subject, not to cross-domain semantic deviations in forecasting systems. The “EO” prefix (Exposure-Output) disambiguates this CIDDS-specific usage.
Triggering condition: a rule (threshold, tiering policy, or multi-factor condition) that initiates a defensive intervention.
Evidence bundle: ** a structured output comprising: top-k contributing exposure items; feature values (f_seq, f_rep, f_tgt, f_syn); computed scores (BDI, IPS, COAS); thresholds applied; temporal windows; baseline reference version; intervention decision; rationale string; provenance metadata; and hash for integrity verification.

### 5.1 System Components (Illustrative)

CIDDS may comprise: (1) Input Interface (II): ingests exposure stream plus user outputs; (2) Semantic Projection Engine (SPE): vectorizes exposures and outputs into a semantic space; (3) Baseline Modeling Engine (BME): maintains stateful, decay-weighted baseline and user fingerprint; (4) Deviation Interpretation Module (DIM): computes BDI and detects EO-CCS signatures; (5) exposure inception analyzer (EIA): computes IPS based on exposure structure and sequencing; (6) Collapse and Explanation Engine (CEE): generates origin assessment plus evidence bundle; (7) Output and Intervention Module (OIM): applies pre-/post-exposure defensive actions based on triggering conditions; (8) Audit and Compliance Module (ACM): tamper-evident logs, evidence export, reporting; (9) Optional Neural Signal Module (NSM): processes non-invasive neurophysiological signals (e.g., EEG) to generate a neural corroboration score.

In certain embodiments, the inception propensity score (IPS) is computed independently from the baseline deviation index (BDI) prior to any fusion operation, such that exposure-structure analysis and user-output deviation analysis remain architecturally decoupled until the cognitive origin authentication stage. This dual-stream independence ensures that exposure-side risk assessment does not contaminate user-side baseline modeling, and vice versa.

### 5.2 Stateful, Decay-Weighted Baseline Modeling

The BME maintains a baseline using a decay function to weight recent history more than older history. One non-limiting example: Let an embedding vector for a user output at time t be uₜ. The baseline centroid μₜ may be updated as:

$${μ}_{t} = ( 1 - λ ) \cdot {μ}_{t {-}_{1}} + λ \cdot {μ}_{t} , where 0 < λ \leq 1.$$

Typical value: λ=0.05 (slow adaptation). Alternatively, a time-decay weight w(Δt)=exp(−κ·Δt) may be used for windowed statistics. CIDDS may store multiple baselines (topic-specific, context-specific, high-stakes domain-specific) with configurable decay constants:
Short-term baseline: κ=0.1, half-life \˜7 days (recent behavioral patterns)
Medium-term baseline: κ=0.023, half-life \˜30 days (established preferences)
Long-term baseline: κ=0.0038, half-life \˜180 days (stable personality/style markers)
Baseline components may include: centroid vector (semantic center); covariance matrix (for Mahalanobis distance); topic distribution (e.g., 50-topic LDA); stylometric profile (vocabulary size, sentence length distribution, punctuation frequency, formality register); decision pattern history (choice sequences, latency distributions).

### 5.3 Baseline Deviation Index (BDI)

A non-limiting BDI computation:

$${BDI}_{t} = ( 1 - cos\_sim ( {u}_{t} , {μ}_{t} ) ) / 2$$

where cos_sim is cosine similarity (range [−1, 1]), yielding BDI∈[0, 1]. For composite BDI incorporating multiple signal types:

$$BDI\_composite = 0.4 \cdot BDI\_semantic + 0.2 \cdot BDI\_stylometric + 0.2 \cdot BDI\_topic + 0.2 \cdot BDI\_temporal$$

Where: BDI_semantic=(1−cos_sim(uₜ,μₜ))/2; BDI_stylometric=KL_divergence(style_t,style_baseline) normalized; BDI_topic=Hellinger_distance(topic_dist_t,topic_dist_baseline); BDI_temporal=|Δopinion/Δt| normalized by historical rate.

### 5.4 Inception Propensity Score (IPS)

CIDDS computes IPS from exposure properties. IPS comprises four feature scores:
f_seq (Sequence priming score, weight 0.30): Degree to which exposures form an ordered trajectory toward a target frame. Computation: embed each exposure item in sequence; compute pairwise similarities; detect convergent paths using linear fit. Score=max(0R²×slope_magnitude). Range [0, 1]. High values indicate structured priming trajectory.

f_rep (Repetition structure score, weight 0.25): Spacing/frequency consistent with retention optimization. Computation: temporal autocorrelation of concept embeddings at 24 h, 48 h, 72 h lags (known retention-optimization intervals). Score=max(0,max(autocorrelation across lags)). Range [0, 1]. High values indicate spaced repetition patterns.

f_tgt (Microtargeting indicator score, weight 0.25): Personalization markers inferred from content variation. Computation: Jensen-Shannon divergence between user\'s content distribution and population baseline, weighted by psychological profile alignment coefficient. Score=JS_div(base-2 logarithm, yielding range [0, 1])×profile_match. Range [0, 1]. High values indicate personalized delivery.

f_syn (Synthetic consensus score, weight 0.20): Indicators of coordinated inauthentic behavior. Computation: detect timing clusters (exposures within 5-minute windows from multiple sources with embedding similarity>0.8); compute coordination_index=cluster_count/total_exposures; multiply by authenticity_doubt_factor (a scalar in [0, 1] derived from inverse source reputation scores, where 0=fully authenticated source and 1=unknown or flagged source). Range [0, 1]. High values indicate manufactured consensus.

All feature scores (f_seq, f_rep, f_tgt, f_syn) are monotonically transformed and clamped to [0, 1] after computation to ensure bounded scoring. Where underlying computations may exceed this range (e.g., unnormalized slope magnitudes or negative autocorrelations), a clamping function min(max(x, 0), 1) is applied.

### IPS Fusion

$$IPS = σ ( α \cdot ( 0.3 \cdot f\_seq + 0.25 \cdot f\_rep + 0.25 \cdot f\_tgt + 0.2 \cdot f\_syn ) + b )$$

where σ is logistic sigmoid: σ(x)=1/(1+exp(−x)); α (scale) and b (intercept) are learned or configured parameters that achieve full-scale sensitivity across the [0, 1] output range. In one non-limiting embodiment, α=10 and b=−3, calibrated via logistic regression on labeled exposure datasets. The sigmoid ensures bounded output in [0, 1].

### 5.5 Coas Fusion and Triggering

COAS fusion combines BDI, IPS, and optional signals:

$$COAS = clamp ( 0.3 \cdot ( 1 - BDI ) + 0.35 \cdot ( 1 - IPS ) + 0.2 \cdot EO\_CCS \_support + 0.15 \cdot NS\_term , 0 , 1 )$$

In another embodiment, the linear score may be passed through a calibrated logistic mapping to produce a probability-like value.

When optional signal modules (EO-CCS, neural signal) are unavailable, their respective weights are redistributed proportionally among active components, with neutral prior values (0.5) applied as fallback. This ensures COAS remains well-defined regardless of available signal modalities.

Where: EO_CCS_support quantifies evidentiary support for the organic origin hypothesis from exposure-output cross-contextual signature analysis: EO_CCS_support=0.0 if EO-CCS detected with p<0.01 (strong inception evidence); EO_CCS_support=0.2 if 0.01≤p<0.05 (moderate inception evidence); EO_CCS_support=0.5 if p≥0.05 (neutral, no significant EO-CCS detected). NS_term=neural corroboration score if available, else 0.5 (neutral). Higher COAS indicates higher confidence in organic origin; lower COAS indicates higher induction risk.

### Triggering Conditions (Non-Limiting Examples):

\(a\) Rule-based: Trigger if (IPS>τ_ips AND BDI>τ_bdi) where τ_ips=0.40, τ_bdi=0.35
\(b\) COAS-based: Tier 1 (COAS<0.70): log+dashboard; Tier 2 (COAS<0.50): label+reflection prompt; Tier 3 (COAS<0.30): throttle+quarantine; Tier 4 (COAS<0.20 AND high-stakes): block+escalate
\(c\) Threat-adjusted: thresholds multiplied by threat_level_modifier (L1: 1.0, L2: 1.1, L3: 1.2)
\(d\) Domain-adjusted: finance/elections: 1.2× sensitivity; casual browsing: 0.8× sensitivity

### 5.6 Collapse and Explanation Engine (Evidence Bundles)

The CEE generates an interpretable origin assessment and a structured evidence bundle containing:
assessment: categorical classification (ORGANIC, MONITORING, ELEVATED_RISK, HIGH_RISK, CRITICAL)
scores: {BDI: float, IPS: float, COAS: float, EO_CCS_support: float, NS_score: float|null}
features: {f_seq: float, f_rep: float, f_tgt: float, f_syn: float}
thresholds_applied: {τ_bdi: float, τ_ips: float, τ_coas: float, threat_modifier: float}
temporal_window: {start: ISO8601, end: ISO8601, duration_hours: int}
baseline_reference: {version: string, last_updated: ISO8601, observation_days: int}
top_k_exposures: [{rank: int, timestamp: ISO8601, source: string, content_hash: SHA256, contribution_score: float}]

The evidence bundle is deterministic given inputs and parameters: identical exposure streams, output signals, and system configuration produce identical scores and evidence records, ensuring reproducibility and auditability.
intervention: {type: string, executed_at: ISO8601, user_response: string|null}
rationale: human-readable explanation string
integrity: {evidence_hash: SHA256, prev_hash: SHA256}

### 5.7 Output and Intervention Module

### Interventions are Graduated Based on Risk Level

### Pre-Exposure Actions (Applied Before Content Reaches User)

Label: inject contextual warning banner
Delay: hold content for configurable interval (1-30 seconds)
Throttle: rate-limit high-IPS content delivery
Quarantine: hold for manual review
Block: prevent delivery entirely

### Post-Exposure Actions (Applied After Exposure Detected)

Reflection prompt: overlay requesting user to consider influence sources
Decision buffer: mandatory delay before high-stakes actions (e.g., 24 h for major decisions)
Second-opinion routing: flag for peer/supervisor review

### Enterprise Actions

Escalation: notify governance/security team
Incident report: generate forensic package
Policy update: trigger threshold recalibration review

### 5.8 Auditability and Tamper-Evident Logging

### ACM Maintains Tamper-Evident Logs With the Following Properties

Hash chaining: Each log entry includes SHA-256 hash of previous entry. entry_hash=SHA256(prev_hash∥JSON(entry_data)). Chain integrity verifiable by recomputation.

Log entry schema: {timestamp: ISO8601, event_type: “exposure”|“output”|“score”|“intervention”|“audit”, user_id_hash: SHA256, payload: object, prev_hash: SHA256, entry_hash: SHA256}
Optional anchoring: Merkle roots may be periodically anchored to external timestamping services (blockchain, RFC 3161 TSA) for third-party verifiability.
Export formats: JSON, XML, PDF report for governance and compliance.

### 5.9 Optional Neurophysiological Embodiments

NSM may process EEG features to provide an additional corroboration channel. Relevant markers (non-limiting):
Gamma-band (30-100 Hz) burst timing: associated with attention and binding [7]
Alpha-band (8-12 Hz) dynamics: associated with inhibition and gating [8]
Theta-gamma cross-frequency coupling: associated with memory encoding
Mismatch negativity/prediction error signatures: may indicate unexpected semantic content

The system remains fully operable without neural hardware; NSM is an optional enhancement that increases evidentiary weight but does not constitute “mind reading.” Neural signals provide statistical correlates of cognitive states, not direct thought access.

### 5.10 Software-only Embodiment (Browser Extension/Mobile App/ Network Proxy)

This section describes a complete software-only embodiment of CIDDS that requires no specialized hardware and can be implemented using standard computing platforms.

### 5.10.1 Architecture Overview

The software-only CIDDS embodiment operates as one of: (a) a browser extension intercepting web content before rendering; (b) a mobile application with accessibility services permissions monitoring content across apps; or (c) a network proxy mediating HTTP/HTTPS traffic. All three variants implement the same core pipeline.

### 5.10.2 Exposure Logging Module

The exposure logging module captures: timestamp (ISO 8601 format, millisecond precision); source URL or application identifier; content type (text, image, video, mixed); content hash (SHA-256 of normalized content); engagement metrics (dwell time in ms, scroll depth percentage, interaction events); and delivery context (feed position, notification type, referrer).
Storage: SQLite database on device with configurable retention windows (7/30/180 days). Privacy: content hashes stored, not full content; user controls data retention and can delete at any time.

### 5.10.3 Semantic Projection Implementation

Embeddings computed using: SBERT (sentence-transformers/all-MiniLM-L6-v2, 384 dimensions) for text; or CLIP (openai/clip-vit-base-patch 32, 512 dimensions) for multimodal. Local inference via ONNX runtime (mobile) or WebAssembly (browser). Embedding computation latency: <50 ms per item on standard hardware (tested on mid-range 2023 smartphone and 2020 laptop).

### 5.10.4 Baseline Computation

User baseline maintained as: centroid vector (exponential moving average, λ=0.05); covariance matrix (for Mahalanobis distance, optional); topic distribution (LDA with 50 topics); stylometric profile (vocabulary size, avg sentence length, punctuation frequency). Update frequency: after each user output event. Storage footprint: <10MB per user.

### 5.10.5 IPS Feature Extraction

f_seq: Compute embedding sequence, fit linear trajectory, score=R² of fit×slope magnitude. f_rep: Compute temporal autocorrelation at 24 h, 48 h, 72 h lags; score=max correlation. f_tgt: Compare user content distribution to cached population baseline (updated weekly via federated aggregation); score=Jensen-Shannon divergence. f_syn: Detect timing clusters (exposures within 5-minute windows from multiple sources with >0.8 embedding similarity); score=cluster_count/total_exposures.

### 5.10.6 Decision Logic

Classifier: Calibrated logistic regression trained on labeled examples (organic vs. induced). Features: [BDI, IPS, f_seq, f_rep, f_tgt, f_syn, time_since_baseline_update, exposure_velocity]. Output: COAS probability. Calibration via Platt scaling on held-out validation set. Thresholds configurable per deployment.

### 5.10.7 Intervention Implementation

Pre-exposure (proxy/extension): inject warning banner before content; delay rendering by configurable interval (1-30 seconds); redirect to interstitial page; block entirely. Post-exposure: inject reflection prompt overlay; trigger notification; log for later review. All interventions logged with timestamp, trigger scores, user response (if any).

### 5.10.8 Audit Trail Format

JSON schema for audit entries: {“timestamp”: “ISO8601”,“event_type”: “exposure|output|intervention”, “scores”: {“BDI”: float, “IPS”: float, “COAS”: float}, “features”: {“f_seq”: float, “f_rep”: float, “f_tgt”: float, “f_syn”: float}, “intervention”: string|null, “prev_hash”: “SHA256”, “entry_hash”: “SHA256”}. Hash chain: entry_hash=SHA256(prev_hash+JSON(entry_without_hash)).

### 5.10.9 Fallback Mode

When baseline is insufficient (observation window<7 days) or data is missing, CIDDS operates in degraded mode: (a) IPS-only scoring using exposure features without BDI comparison; (b) population-level baseline substitution using anonymized aggregate statistics; (c) elevated logging with reduced intervention (advisory only). System automatically transitions to full operation once baseline observation threshold is met.

### 5.11 Enterprise Gateway/Secure Proxy Embodiment (Pre-Exposure Enforcement)

In another embodiment, CIDDS is deployed as an enterprise gateway or secure proxy positioned between user devices and external content sources. The gateway intercepts or mediates delivery of exposure streams to protected users.

The gateway may enforce organizational policies by applying pre-exposure interventions based on IPS alone (e.g., quarantine high-risk items) or based on fused scores (IPS+BDI+contextual risk) when user baseline data is available via privacy-preserving federation. Pre-exposure intervention latency target: <100ms for real-time content mediation.

The Gateway Embodiment Supports Role-based Risk Tiers (e.g., Executive: highest sensitivity; analyst: high; operator: standard), domain-specific thresholds (e.g., financial news: elevated; social media: high; internal comms: standard), and signed audit logs suitable for governance and incident response.

### 5.12 Privacy-by-Design and Data Minimization

CIDDS implements privacy-by-design principles throughout the architecture:

### 5.12.1 Local-First Baseline Processing

All baseline computation occurs on-device by default. Embedding vectors, topic distributions, and stylometric profiles are computed and stored locally. No raw user cognitive outputs are transmitted to any external server in the default configuration.

### 5.12.2 Data Minimization

Content hashes stored, not full content. User outputs processed locally; only aggregate statistics exported if federated learning enabled. No personally identifiable information required for core operation. Minimal data collection principle: capture only signals necessary for BDI/IPS computation.

### 5.12.3 User Control and Transparency

Users may view, export, and delete their baseline data at any time. Retention windows configurable (default: 30 days for exposure logs, 180 days for baseline). Intervention aggressiveness adjustable via user preferences. Full audit trail accessible to user.

### 5.12.4 Selective Field Hashing

Evidence bundles use selective field hashing to enable integrity verification while preserving privacy. Example: top_k_exposures contains content_hash (not content); user_id stored as SHA-256 hash; rationale generated without including verbatim user text.

### 5.12.5 Federated Learning (Optional)

When baseline calibration benefits from population-level statistics: (a) local gradients computed on-device; (b) only aggregated, differentially-private (ε=1.0, δ=10⁻⁵) updates transmitted; (c) no raw user data leaves device; (d) participation optional and user-controlled.

### 5.12.6 High-Sensitivity Decision-Maker Mode

For executive protection deployments: enhanced logging granularity; evidence bundles retained with extended TTL; no external data transmission; air-gapped operation option; hardware security module (HSM) integration for key management.

### 5.12.7 Identifier Rotation

Internal user identifiers rotate on configurable schedule (default: 90 days) to limit longitudinal tracking potential. Cross-session continuity maintained via secure token refresh, not persistent identifiers.

### 5.12.8 Compliance Alignment

Architecture designed for compatibility with: GDPR (data minimization, purpose limitation, right to erasure, data portability); CCPA (disclosure, deletion rights, opt-out); EU AI Act (transparency, human oversight, record-keeping); NIST AI RMF (risk management, governance).

### 5.13 Reference Implementation Parameters (Non-Limiting Defaults)

The following table provides non-limiting default parameter values for a reference implementation. These values may be adjusted based on deployment context, threat environment, and operational requirements.

### Decay Parameters (λ/κ)

Short-term (24 h context): λ=0.20, κ=0.693 (half-life \˜1 day)
Medium-term (weekly context): λ=0.05, κ=0.099 (half-life \˜7 days)
Long-term (monthly context): λ=0.01, κ=0.023 (half-life \˜30 days)
Stable baseline: λ=0.005, κ=0.0038 (half-life \˜180 days)

### Triggering Thresholds

τ_COAS: 0.45 (default), 0.55 (high-sensitivity), 0.35 (low-sensitivity)
τ_IPS: 0.40 (default), 0.30 (high-sensitivity), 0.50 (low-sensitivity)
τ_BDI: 0.35 (default), 0.25 (high-sensitivity), 0.45 (low-sensitivity)

### Temporal Window

Exposure→Output correlation window (Δt): 72 hours (default), 24-168 hours (configurable)
EO-CCS detection window: 48 hours (default)
Baseline minimum observation period: 7 days (degraded mode below this)
Baseline full operation threshold: 14 days

### Latency Targets

Pre-exposure gateway intervention: <100 ms (hard target)
Post-exposure scoring: <500 ms (soft target)
Audit log write: <50 ms
Embedding computation (per item): <50 ms
Fallback mode activation: automatic when latency exceeds 2× target

### IPS Feature Weights

w_seq (sequence priming): 0.30
w_rep (repetition structure): 0.25
w_tgt (microtargeting): 0.25
w_syn (synthetic consensus): 0.20

### COAS Fusion Weights

w_BDI: 0.30
w_IPS: 0.35
w_EO_CCS_support: 0.20
w_NS (neural, when available): 0.15 (else redistributed)
Note: These parameters represent one mode of implementation. Practitioners may calibrate values based on validation data, deployment context, and risk tolerance.

### 5.14 Algorithmic Implementation (Pseudocode)

The following pseudocode illustrates a non-limiting implementation of the core CIDDS pipeline:

FUNCTION CIDDS_Process(user_id, timestep t):
//Initialize baseline if needed
   IF baseline[user_id] NOT EXISTS:
baseline[user_id]=InitializeBaseline(user_id, observation_window=14_days)
mode=FALLBACK // IPS-only until baseline sufficient
   ELSE IF baseline[user_id]. observation_days<7
mode=FALLBACK

### ELSE:

mode=FULL
//Parameters (see Section 5.13 for defaults)//α=10, b=−3//IPS calibration (logistic scale/intercept)
λ=0.05; τ_bdi=0.35; τ_ips=0.40; τ_coas=0.45
w={f_seq: 0.30, f_rep: 0.25, f_tgt: 0.25, f_syn: 0.20}
//Get inputs
exposure=GetContentExposureStream(user_id, window=48_hours)
output=GetUserCognitiveOutput(user_id, t)
//Semantic projection (standalone, no QSP-EF dependency)
e_vectors=[SemanticEmbed(item) FOR item IN exposure.items]//SBERT/CLIP
u_vector=SemanticEmbed(output)
//Compute BDI (skip if FALLBACK)
   IF mode==FULL

BDI=(1−CosineSimilarity(u_vector,baseline[user_id].centroid))/2

### ELSE

BDI=0.5//Neutral when baseline unavailable
//Compute IPS features
f_seq=SequencePrimingScore(exposure)
f_rep=RepetitionStructureScore(exposure)
f_tgt=MicrotargetingScore(exposure, user_profile)
f_syn=SyntheticConsensusScore(exposure)
S=w.f_seq*Clamp(f_seq,0,1)+w.f_rep*Clamp(f_rep,0,1)+w.f_tgt*Clamp(f_tgt,0,1)+w.f_syn*Clamp(f_syn,0,1) IPS=Sigmoid(α*S+b)//α, b: calibration parameters (see Section 5.4)
//Detect EO-CCS (renamed from CCS for clarity)
EO_CCS=DetectExposureOutputSignature(e_vectors, u_vector, temporal_window=72_hours)
EO_CCS_support=0.0 IF EO_CCS.detected AND EO_CCS.p_value<0.01 ELSE 0.2 IF EO_CCS.detected AND EO_CCS.p_value<0.05 ELSE 0.5
//Compute COAS

COAS=Clamp(0.30*(1−BDI)+0.35*(1−IPS)+0.20*EO_CCS_support+0.15*NS_term,0,1)
//Threat level classification
threat_level=ClassifyThreatLevel(f_seq, f_rep, f_tgt, f_syn)
adjusted_τ=τ_coas*threat_level.modifier
//Intervention decision
intervention=NULL

### IF COAS<adjusted_τ

IF mode==FALLBACK
intervention=“ADVISORY_LOG”//Reduced intervention in fallback
   ELIF COAS<0.20 AND context_risk==HIGH_STAKES
intervention=“BLOCK_ESCALATE”

### ELIF COAS<0.30 OR IPS>0.70

intervention=“QUARANTINE”

### ELIF IPS>τ_ips AND BDI>τ_bdi

intervention=“REFLECTION_PROMPT”

### ELSE

intervention=“LABEL”
ExecuteIntervention(intervention, user_id, output)
//Generate evidence bundle
evidence=GenerateEvidenceBundle(
scores={BDI, IPS, COAS, EO_CCS.score},
features={f_seq, f_rep, f_tgt, f_syn},
thresholds={τ_bdi, τ_ips, adjusted_τ},
threat_level=threat_level,
exposure_metadata=exposure.metadata,
intervention=intervention
//Tamper-evident logging
prev_hash=GetLastLogHash(user_id)
entry_hash=SHA256(prev_hash+JSON(evidence))
LogEvent(timestamp=t, user_id_hash=SHA256(user_id), scores, intervention, entry_hash, prev_hash)
//Update baseline (if FULL mode)
   IF mode==FULL

baseline[user_id].centroid=(1−λ)*baseline[user_id].centroid+λ*u_vector
baseline[user_id].UpdateStatistics(output)
RETURN {COAS, intervention, evidence, mode}

### 5.15 Multimodal Content Exposure Processing

The CIDDS is configured to process multimodal content exposure streams comprising two or more of: text, image, audio, video, augmented reality overlays, or haptic signals. Each modality is transformed by modality-specific feature extractors into representations within the shared multidimensional semantic vector space defined in Section 5.1.

For textual content, the semantic projection engine applies contextual embedding models to generate dense vector representations. For image content, visual feature extraction produces semantic descriptors encoding objects, composition, emotional valence, and contextual associations. For audio content, spectral and prosodic features are extracted alongside speech-to-text transcription where applicable. For video content, temporal sequences of visual and audio features are aggregated with attention-weighted pooling.

The IPS computation (Section 5.4) operates on the unified semantic space, enabling cross-modal inception detection. For example, a priming sequence may consist of visual content followed by textual reinforcement, detectable only through cross-modal semantic trajectory analysis.

### 5.16 Wearable and Augmented Reality Embodiments

### 5.16.1 Head-mounted Display Integration

In embodiments comprising a wearable device such as smart glasses, a head-mounted display (HMD), or an augmented reality (AR) device, the CIDDS mediates content delivery through the device render pipeline. The system intercepts content destined for display, computes IPS and BDI scores, and applies defensive actions including visual annotation, overlay warnings, content delay, or content blocking prior to rendering.

The wearable device interface operates as an observer and mediator of exposure streams. The system does not require generation, emission, or control of any external signals. All sensing is passive and defensive.

### 5.16.2 Sensor-Derived Environmental Descriptors

In certain embodiments, the IPS computation further incorporates sensor-derived environmental descriptors captured by device sensors. These descriptors may include: acoustic descriptors (ambient sound characteristics, speech patterns), illumination or flicker descriptors (display modulation patterns, environmental lighting anomalies), and electromagnetic or radio-frequency (EM/RF) signature descriptors captured by device radio receivers operating in passive monitoring mode.

The incorporation of sensor-derived descriptors enables detection of environmental manipulation techniques that may not be observable through content analysis alone, while maintaining the system's non-offensive, observer-only posture.

### 5.16.3 Calibration Engine and Drift Monitoring

The CIDDS includes a calibration engine configured to maintain parameterized functions whose weights are calibrated based on domain-specific feedback signals. The calibration engine enables adaptation to different deployment contexts (enterprise, defense, consumer) without requiring architectural modification.

A drift monitoring module continuously evaluates distributional properties of both the content exposure stream and user cognitive output signals. Upon detection of statistically significant distributional shift exceeding a configurable sensitivity threshold, the drift monitoring module triggers recalibration of the baseline modeling engine and adjustment of triggering conditions. This ensures system accuracy is maintained as content ecosystems and user behavior evolve over time.

Worked Examples with Explicit Calculations

### With Explicit Calculations

### 6.1 Example A: Organic Cognitive Drift (No Intervention)

Scenario: A financial analyst (User A) naturally develops interest in cryptocurrency over 30 days through self-directed research.

### Day 1—Baseline Establishment

Baseline centroid μ₀ established from 14-day observation window. User topics: {finance: 0.45, markets: 0.30, regulation: 0.15, other: 0.10}. Stylometric baseline: avg_sentence_length=18.2, vocabulary_size=2847, formal_register=0.72.
   Day 7—User Searches “bitcoin Fundamentals”
Exposure stream: 3 articles from mainstream financial news (Reuters, Bloomberg, FT).
Feature extraction: f_seq=0.05 (no trajectory structure; random topic entry). f_rep=0.02 (single exposure event, no repetition). f_tgt=0.08 (generic content, minimal personalization—same articles shown to broad audience). f_syn=0.01 (established news sources, no coordination markers).
IPS calculation: IPS=σ(α·(0.30×0.05+0.25×0.02+0.25×0.08+0.20×0.01)+b)=σ(10·(0.015+0.005+0.02+0.002)+(−3))=σ(10·0.042 −3)=σ(−2.58)=IPS=0.07
User output: Email mentioning crypto curiosity. u₇ embedding similarity to μ₀: 0.88.

BDI=(1−0.88)/2=0.06
EO-CCS check: Exposure-output similarity=0.45 (moderate, expected for on-topic discussion). Statistical significance: assessed via permutation test over the user\'s similarity distribution, p=0.23 (not significant). EO_CCS_support=0.5.
COAS=clamp(0.30×(1−0.06)+0.35×(1−0.07)+0.20×0.5+0.15×0.5,0,1)=clamp(0.282+0.326+0.10+0.075,0,1)=clamp(0.783,0,1)=COAS=0.78 (organic, high confidence)
Threat level: Level 1 (organic). Decision: COAS=0.78>0.70 (organic threshold). Action: No intervention. Organic cognition confirmed.

### Day 30—Sustained Interest

BDI=0.24 (gradual drift incorporated into baseline updates via decay weighting).
IPS=0.12 (consistent low-risk exposure pattern).
COAS=0.81
Baseline has adapted: new topics include {crypto: 0.12}. No intervention. Organic evolution confirmed.

### 6.2 Example B: Induced Cognitive Trajectory (Intervention Triggered)

Scenario: An executive (User B) is targeted by coordinated influence campaign to shift opinion on pending acquisition decision.

### Day 1—Baseline

Baseline established from 14-day observation. User stance on acquisition: neutral.

### Day 2-5—Progressive Exposure Campaign

Day 2: LinkedIn “Industry consolidation inevitable” (f_seq=0.15, f_tgt=0.22, f_syn=0.18). IPS=0.22, BDI=0.05, COAS=0.84.
Day 3: Email forward “Competitor X acquiring Y” (f_seq=0.35, f_rep=0.28, f_tgt=0.38, f_syn=0.32). IPS=0.31, BDI=0.14, COAS=0.72. EO-CCS detected (p<0.01).
Day 4: News feed 3 articles on acquisition benefits (f_seq=0.58, f_rep=0.52, f_tgt=0.55, f_syn=0.38). IPS=0.48, BDI=0.32, COAS=0.54.
Day 5: WhatsApp “trusted contact” endorses deal (f_seq=0.72, f_rep=0.58, f_tgt=0.65, f_syn=0.44). IPS=0.65, BDI=0.47, COAS=0.38

### Day 6—Intervention Triggered

Triggering conditions met: COAS (0.38)<τ_coas (0.45); IPS (0.65)>τ_ips (0.40); BDI (0.47)>τ_bdi (0.35). Context: M&A decision=HIGH_STAKES. Threat level: 3 (CIB).
Intervention executed: REFLECTION_PROMPT+DECISION_BUFFER_24H

### 6.3 Example C: Conflicting Modality Signals

Scenario: High BDI (0.52) but low IPS (0.15). Significant baseline deviation without corresponding exposure-side risk.
Analysis: Suggests genuine life change, unmonitored exposure channels, or delayed effects.

COAS=Clamp(0.144+0.2975+0.10+0.075,0,1)=0.62
Decision: COAS in monitoring range. Manual review flagged, no aggressive intervention.

### 6.4 Comparative Summary Table**

   |Metric|Ex. A (Organic)|Ex. B (Induced)|Ex. C (Incongruent)
   |\-\-\-\-\-\-\-\-\-\--|\-\-\-\-\-\-\-\-\-\-\-\-\-\-\-\--|\-\-\-\-\-\-\-\-\- \-\-\-\-\-\-\--|\-\-\-\-\-\-\-\-\-\-\-\-\-\-\-\-\-\-\-\--|
   |IPS|0.12|0.65|0.15|
   |BDI|0.24|0.47|0.52|
   |COAS|0.7|0.38|0.62|
   |Threat|L1|L3|Unknown|
   |EO-CCS|No|Yes (p<0.01)|No|
   |Intervention|None|REFLECTION+BUFFER|Manual Review|

### Validation Protocol (Non-Limiting)

### Protocol (Non-Limiting)

This section describes non-limiting validation approaches to assess CIDDS operational effectiveness.

### 7.1 Offline Validation

Dataset: Labeled episodes of organic vs. induced cognitive trajectories. Sources may include: (a) simulated campaigns with known parameters; (b) historical documented influence operations with consent-obtained user data; (c) A/B exposure experiments under IRB approval.

### Metrics

AUC-ROC for COAS classification (organic vs. induced)
Precision/Recall at operating thresholds
False Positive Rate (FPR) by threat level: target FPR<0.05 for L1, <0.10 for L2, <0.15 for L3
False Negative Rate (FNR) by threat level: target FNR<0.10 for L3, <0.15 for L2
Time-to-detection: mean and 95th percentile latency from first induction exposure to intervention

### 7.2 Ablation Studies

Component contributions assessed by comparing:
Full model (BDI+IPS+EO-CCS)
IPS-only (exposure features without baseline)
BDI-only (baseline deviation without exposure analysis)
Individual feature ablation (remove f_seq, f_rep, f_tgt, f_syn individually)
Expected result: Full model outperforms single-stream variants, validating dual-stream architecture.

### 7.3 Latency Benchmarks

Pre-exposure gateway: target<100 ms end-to-end (content intercept→IPS compute→policy decision→intervention execute)
Post-exposure scoring: target<500 ms (output capture→embedding→BDI compute→COAS fusion→log)
Audit log write: target<50 ms (hash computation+append)

### 7.4 User Experience Metrics

Intervention acceptance rate: proportion of reflection prompts where user engages (target>60%)
False alarm fatigue: track user dismissal patterns; adapt thresholds if dismissal rate>80%
Decision quality: where measurable, compare decision outcomes with/without CIDDS intervention

### 7.5 Online Red-Team Simulation

Red-team validation simulates adversarial campaigns against CIDDS-protected users:

### Attack Classes Simulated

Level 1 (Organic): Static persuasive content without targeting
Level 2 (Algorithmic): Profile-matched content with engagement optimization
Level 3 (CIB): Multi-source coordinated campaigns with synthetic consensus

### Attack Replay

Historical campaign sequences (e.g., documented influence operations) replayed against test users with consent. Measures: detection latency, intervention accuracy, false positive rate.

### Channel Ablation

Assess robustness when exposure channels are partially occluded: (a) without location metadata; (b) without targeting indicators; (c) without timing data. System should degrade gracefully, not fail catastrophically.

### Adversarial Evasion

Test against adversaries who know CIDDS detection logic: (a) slow-drip priming (extend trajectory over weeks); (b) noise injection (irrelevant exposures to mask trajectory); (c) channel hopping (distribute campaign across platforms). Measure: does COAS still detect induced trajectory at acceptable FNR?
Success Criteria:**
L3 attack detection: >90% within 72 hours
L2 attack detection: >80% within 96 hours
FPR on organic users: <5%
Graceful degradation: no more than 20% accuracy loss under channel ablation

### Feature Specification and Interpretation Tables

### Specification and Interpretation Tables

### 8.1 BDI Interpretation Ranges

0.00-0.15: Stable, consistent with baseline (no concern)
0.15-0.30: Normal drift, organic evolution (monitor)
0.30-0.50: Elevated deviation, intervention threshold (act)
0.50-1.00: Significant deviation, high-priority intervention (urgent)

### 8.2 IPS Interpretation Ranges

0.00-0.20: Low induction likelihood; typical content (clear)
0.20-0.40: Moderate indicators; enhanced monitoring (watch)
0.40-0.60: Elevated risk; intervention threshold (intervene)
0.60-1.00: High induction likelihood; aggressive intervention (block)

### 8.3 COAS Interpretation Ranges

0.70-1.00: High confidence organic origin (normal operation)
0.50-0.70: Moderate confidence; monitoring mode (enhanced logging)
0.30-0.50: Low confidence; intervention threshold (prompt/throttle)
0.00-0.30: High induction risk; aggressive intervention (block/escalate)

### 8.4 Threat Level Response Matrix

Level 1 (Organic): threshold_modifier=1.0, response=standard logging
Level 2 (Algorithmic): threshold_modifier=1.1, response=enhanced monitoring+pre-exposure labeling
Level 3 (CIB): threshold_modifier=1.2, response=aggressive intervention+quarantine+escalation

### 8.5 EO-CCS Detection Thresholds**

p<0.01: High confidence EO-CCS detected, EO_CCS_support=0.0 (strong inception evidence)
0.01 ≤p<0.05: Moderate confidence EO-CCS detected, EO_CCS_support=0.2 (moderate inception evidence)
p≥0.05: No significant EO-CCS, EO_CCS_support=0.5 (neutral, no inception evidence)

### Distinctions Over Related Approaches

### Over Related Approaches*

Note: The following section is provided for clarity and does not constitute an admission that any referenced system or approach constitutes prior art. The comparisons are illustrative and non-limiting. No statements herein should be construed as admissions regarding the patentability of any referenced system.

### 9.1 Distinction From Content Classification/Misinformation Detection

CIDDS does not classify content truth value; it assesses influence pathway and effect on individual cognition. CIDDS analyzes the relationship between exposure and user output, not content in isolation.

### 9.2 Distinction From Bot/CIB Detection Systems

CIDDS focuses on effect on the individual user, not network-level coordination alone. CIDDS incorporates exposure-to-output pathway analysis (BDI), not merely source authenticity.

### 9.3 Distinction From Psychological Profiling/Scoring Systems

CIDDS maintains a stateful, decay-weighted personal baseline, not population-level profiles. CIDDS executes defensive interventions including pre-exposure gating, not merely classification.

### 9.4 Distinction From Mental State Monitoring Systems

CIDDS jointly analyzes exposure stream properties AND user output. CIDDS computes exposure-side IPS to assess causation pathway*, not merely behavioral correlation.

### 9.5 Distinction From Adaptive Content Delivery Systems

CIDDS operates on behalf of the user/defender, not the content provider. CIDDS detects and defends against optimization patterns, rather than implementing them.

### 9.6 Summary of Distinguishing Features

CIDDS presents a novel combination: (1) Dual-signal architecture (IPS+BDI); (2) Pre-exposure defense; (3) Trajectory analysis; (4) Cognitive origin authentication (COAS); (5) Defensive intervention hierarchy; (6) Tamper-evident audit; (7) Threat-level-aware calibration; (8) Privacy-by-design; (9) Standalone operation.

### Exemplary Deployment Embodiments

### Deployment Embodiments

### 10.1 Executive/high-value Decision Maker Protection

CIDDS mediates exposure streams, monitors baseline drift, applies graduated interventions, and produces audit logs for governance.

### 10.2 Defense/Intelligence Analytic Protection

CIDDS acts as an exposure gateway and decision buffer for analysts, detects coordinated influence patterns.

### 10.3 Consumer Cognitive Sovereignty

CIDDS may run on-device with privacy-preserving baseline modeling and browser/app gateway.

### 10.4 Platform/regulatory Compliance**

CIDDS may be integrated into content pipelines for EU AI Act, GDPR, NIST AI RMF compliance.

### Advantages Over Conventional Approaches

### Over Conventional Approaches**

1. Establishes cognitive security as a technical, auditable discipline with quantified metrics.
2. Combines exposure-side scoring (IPS) with individualized baseline drift (BDI) for dual-stream analysis.
3. Provides origin scoring (COAS) with explicit triggering conditions and graduated interventions.
4. Enables pre-exposure and post-exposure defenses via gateway and intervention modules.
5. Provides tamper-evident auditability with hash-chained evidence bundles.
6. Remains modality-agnostic; optional EEG embodiments enhance but do not constrain operation.
7. Operates standalone without requiring integration with upstream AI systems.
8. Software-only embodiment fully implementable on standard computing platforms.
9. Threat-level-aware response calibration for proportionate intervention.
10. Privacy-by-design architecture with on-device processing and user control.
11. Clear separation from pipeline security (CSL) while maintaining portfolio coherence.
12. Reference implementation parameters enable reproducible deployment without undue experimentation.
13. The system improves the technical functioning of content delivery systems by introducing a pre-render enforcement layer that alters data flow and rendering behavior prior to user presentation, thereby modifying the operation of the computing system itself rather than merely presenting advisory information.

### GLOSSARY OF TERMS

BDI: Baseline Deviation Index—quantifies deviation of user output from personal baseline
IPS: Inception Propensity Score—quantifies induction likelihood from exposure structure
COAS: Cognitive Origin Authentication Score—fused estimate of organic vs. induced origin
EO-CCS: Exposure-Output Cross-Contextual Signature—statistically unlikely exposure-output semantic convergence (CIDDS-specific; distinct from CCS in QSP-EF). The derived variable EO_CCS_support is a scalar term used in COAS fusion; lower values correspond to stronger inception evidence (0.0=strong inception evidence; 0.5=neutral/no significant EO-CCS)
CIB: Coordinated Inauthentic Behavior—multi-actor campaigns with manufactured consensus
Evidence bundle: Structured output with scores, features, thresholds, provenance, and rationale
Cognitive security: Protection of human cognition against covert manipulation
Pre-exposure gating: Intervention applied to content before user exposure
Triggering condition: Rule or threshold initiating defensive intervention
Threat level: Classification of manipulation sophistication (L1: organic, L2: algorithmic, L3: CIB)
Decay-weighted baseline: User model with exponential time decay prioritizing recent behavior

### REFERENCES (NON-PATENT LITERATURE)

### Non-Patent Literature

Note: References are provided for scientific context and to establish the technical foundation of the threat model. Nothing herein constitutes an admission that any cited work anticipates or renders obvious the claimed invention.
[1] Kosinski, M., Stillwell, D., & Graepel, T. (2013). Private traits and attributes are predictable from digital records of human behavior. Proceedings of the National Academy of Sciences, 110(15), 5802-5805.
[2] Matz, S. C., Kosinski, M., Nave, G., & Stillwell, D. J. (2017). Psychological targeting as an effective approach to digital mass persuasion. Proceedings of the National Academy of Sciences, 114(48), 12714-12719.
[3] Kramer, A. D., Guillory, J. E., & Hancock, J. T. (2014). Experimental evidence of massive-scale emotional contagion through social networks. Proceedings of the National Academy of Sciences, 111(24), 8788-8790.
[4] Bargh, J. A., Chen, M., & Burrows, L. (1996). Automaticity of social behavior: Direct effects of trait construct and stereotype activation on action. Journal of Personality and Social Psychology, 71(2), 230-244.
[5] Weingarten, E., Chen, Q., McAdams, M., Yi, J., Hepler, J., & Albarracín, D. (2016). From primed concepts to action: A meta-analysis of the behavioral effects of incidentally presented words. Psychological Bulletin, 142(5), 472-497.
[6] Cresci, S. (2020). A decade of social bot detection. Communications of the ACM, 63(10), 72-83.
[7] Fries, P. (2005). A mechanism for cognitive dynamics: Neuronal communication through neuronal coherence. Trends in Cognitive Sciences, 9(10), 474-480.
[8] Klimesch, W. (1999). EEG alpha and theta oscillations reflect cognitive and memory performance: A review and analysis. Brain Research Reviews*, 29(2-3), 169-195.

### PRIORITY AND RELATED APPLICATIONS

### And Related Applications

This non-provisional application claims priority under 35 U.S.C. § 119(e) to U.S. Provisional Patent Application No. 63/954,990 , filed Jan. 6, 2026, the entire disclosure of which is incorporated herein by reference.

This application is related to and builds upon: U.S. patent application Ser. No. 19/231,235 (QSP-EF); and related provisional applications in the Project 47 portfolio addressing semantic forecasting, compliance monitoring, and security, including the Cognitive Security Layer (CSL) for pipeline integrity protection.

### 16.1 Portfolio Coherence Note**

The Project 47 portfolio comprises distinct, complementary systems:
QSP-EF (semantic forecasting engine), CSL (pipeline security), and CIDDS (human cognitive security). CIDDS operates independently and does not depend on QSP-EF or CSL for operation, though integration is possible. Claims in this application are directed to CIDDS-specific elements (exposure stream analysis, COAS, pre-exposure gating, human baseline modeling) that are not claimed in QSP-EF or CSL applications.

The applicant reserves the right to file continuation-in-part applications, divisional applications, and international applications based on this disclosure.

### No Admission of Prior Art

### Of Prior Art

The descriptions, comparisons, references to scientific literature, and references to related approaches in this specification are provided for technical context and clarity only.

Nothing herein shall be construed as an admission that any referenced material constitutes prior art against this application or any related application.

While elements of personalization, persuasion analytics, anomaly detection, and content moderation are known in the field, the present disclosure integrates exposure-stream provenance analysis, stateful decay-weighted baseline modeling of user outputs, exposure-side inception propensity scoring with multi-factor feature extraction (f_seq, f_rep, f_tgt, f_syn), fused cognitive-origin authentication scoring (COAS), threat-level-aware threshold calibration, and real-time defensive interventions with tamper-evident auditability in a single operational pipeline—a combination not taught or suggested by the prior art of record*.

What is claimed is:

1. A computer-implemented cognitive security system for detecting cognitive inception risk and generating defensive interventions, comprising: an input interface configured to receive (i) a content exposure stream comprising a time-stamped sequence of content items associated with a user, including provenance metadata, and (ii) user cognitive output signals comprising at least one of text, speech, selections, or interaction events; a semantic projection engine configured to transform the content exposure stream and the user cognitive output signals into representations in a multidimensional semantic vector space; a baseline modeling engine configured to maintain a user-specific baseline model of semantic and behavioral patterns using a stateful and decay-weighted history; a deviation interpretation module configured to compute, relative to the baseline model, at least (i) a baseline deviation index quantifying deviation of user outputs from the baseline and (ii) an inception propensity score derived from structural properties of the content exposure stream; a collapse and explanation engine configured to generate a cognitive origin authentication score and an interpretable origin assessment based on the baseline deviation index and the inception propensity score; and an output and intervention module configured to, responsive to the cognitive origin authentication score satisfying a triggering condition, intercept, delay, modify, or block delivery of at least one content item from the content exposure stream prior to rendering or presentation on a user device, or generate at least one defensive action comprising alerting, reflection prompting, exposure throttling, quarantine, or blocking.

2. A computer-implemented method for cognitive inception defense, comprising: receiving a content exposure stream comprising a time-stamped sequence of content items with provenance metadata, and user cognitive output signals; projecting the content exposure stream and the user cognitive output signals into a multidimensional semantic vector space; maintaining a user-specific baseline model with stateful and decay-weighted updating; computing a baseline deviation index relative to the baseline model; computing an inception propensity score for the content exposure stream based on at least one of semantic priming patterns, sequencing properties, repetition structure, microtargeting indicators, or synthetic consensus indicators; computing a cognitive origin authentication score by combining the baseline deviation index and the inception propensity score; and upon the cognitive origin authentication score satisfying a triggering condition, intercepting at least one content item from the content exposure stream prior to rendering or presentation on a user device and generating a defensive intervention selected from alerting, reflection prompting, exposure throttling, quarantine, or blocking.

3. A non-transitory computer-readable medium storing instructions that, when executed by one or more processors, cause the processors to perform the method of claim 2.

4. A content-delivery gateway device for cognitive inception defense, comprising: a network interface configured to intercept or mediate delivery of a content exposure stream to a user device; one or more processors configured to execute a semantic projection engine, a baseline modeling engine, a deviation interpretation module, and a collapse and explanation engine and a pre-exposure intervention interface configured to apply a defensive action to the content exposure stream based on the inception propensity score before delivery to the user.

5. The system of claim 1, wherein the baseline modeling engine maintains a personal semantic fingerprint comprising distributional statistics of topics, sentiment, stylistic markers, and decision patterns.

6. The system of claim 1, wherein the deviation interpretation module detects exposure-output cross-contextual signatures (EO-CCS) by identifying a statistically unlikely semantic convergence between the content exposure stream and subsequent user cognitive output signals within a defined temporal window.

7. The system of claim 1, wherein the inception propensity score is computed using a sequence model that evaluates ordering effects and assigns increased risk to multi-step priming trajectories.

8. The system of claim 1, wherein the collapse and explanation engine generates an evidence bundle comprising features, thresholds, provenance metadata, and a human-readable rationale.

9. The system of claim 1, wherein the output and intervention module implements graduated enforcement comprising at least two of reflection prompting, exposure throttling, quarantine, or blocking.

10. The system of claim 1, further comprising an audit module configured to store tamper-evident logs of exposures, scores, thresholds, and interventions.

11. The system of claim 10, wherein the tamper-evident logs are cryptographically chained using sequential hash linking.

12. The system of claim 1, wherein the user cognitive output signals comprise on-device signals including typing dynamics, dwell time, cursor movement, or interaction latency.

13. The system of claim 1, further comprising a neural-signal module configured to process non-invasive neurophysiological signals, and wherein the cognitive origin authentication score further depends on a neural corroboration score.

14. The system of claim 13, wherein the non-invasive neurophysiological signals comprise EEG, and the neural corroboration score includes at least one of gamma-band burst features, alpha-band dynamics, or cross-frequency coupling measures.

15. The method of claim 2, further comprising updating the baseline model using federated learning without exporting raw user cognitive output signals.

16. The content-delivery gateway device of claim 4, wherein the pre-exposure intervention is executed with latency below 100 milliseconds.

17. The system of claim 1, wherein the triggering condition comprises a threshold rule combining the cognitive origin authentication score with a contextual risk level associated with a content domain.

18. The system of claim 1, wherein the triggering condition is adjusted based on a detected threat level selected from organic manipulation, algorithmic manipulation, or coordinated inauthentic behavior.

19. The system of claim 1, wherein the inception propensity score is computed using indicators of coordinated inauthentic behavior or synthetic consensus signals.

20. The system of claim 1, wherein the system is configurable for at least one of enterprise, defense, or critical decision-maker protection deployments with role-based risk tiers.

21. The system of claim 1, further comprising a privacy module implementing on-device processing, user-controlled data retention, selective field hashing, and optional federated learning.

22. The system of claim 1, wherein the system operates independently without requiring integration with any upstream semantic forecasting or AI pipeline system.

23. The system of claim 1, wherein the input interface is further configured to receive multimodal content exposure streams comprising at least two of text, image, audio, video, augmented reality overlays, or haptic signals, and the semantic projection engine is configured to transform each modality into the shared multidimensional semantic vector space.

24. The system of claim 1, further comprising a wearable device interface configured to mediate content delivery through a head-mounted display, smart glasses, or augmented reality device, wherein the output and intervention module is configured to intercept and modify the render pipeline of the wearable device to implement defensive actions.

25. The system of claim 1, wherein the inception propensity score further incorporates sensor-derived environmental descriptors comprising at least one of acoustic descriptors, illumination or flicker descriptors, or electromagnetic or radio-frequency signature descriptors captured by device sensors, without requiring generation, emission, or control of any external signals.

26. The system of claim 1, further comprising a calibration engine configured to maintain parameterized functions whose weights are adapted based on domain-specific feedback, and a drift monitoring module configured to detect distributional changes in the content exposure stream or user cognitive output signals and trigger recalibration of the baseline modeling engine.
